(19) United States
(12) Patent Application Publication
(10) Pub. No.: US 2017/0363759 A1
(43) Pub. Date: Dec. 21, 2017

(54) SYSTEM AND METHOD FOR SEISMIC INTERFEROMETRY OPTIMIZED DATA ACQUISITION

(71) Applicant: CGG SERVICES SA, Massy Cedex (FR)

(72) Inventors: Benoit DE CACQUERAY, Clamart (FR); Jean-Charles FERRAN, Fontainebleau (FR)

(21) Appl. No.: 15/266,216

(22) Filed: Sep. 15, 2016

Related U.S. Application Data
(60) Provisional application No. 62/351,405, filed on Jun. 17, 2016.

(51) Int. Cl. G01V 1/36; G01V 1/02; G01V 1/24

(52) U.S. Cl. CPC G01V 1/36; G01V 1/247; G01V 1/02; G01V 2210/121; G01V 2210/72; G01V 2210/74; G01V 2210/675

(57) ABSTRACT

Systems and methods for improving or generating an image of a surveyed subsurface based on seismic interferometry. A method includes actuating interferometry-based sources over an area to be surveyed to generate seismic waves; recording seismic signals due to the interferometry-based sources, with seismic receivers; selecting traces corresponding to a pair of seismic receivers and an interferometry-based source such that ray paths between the interferometry-based source and the pair of seismic receivers contribute to a Green's function between the two receivers of the pair; cross-correlating the traces for calculating an earth's response associated with a ray propagating from a first seismic receiver of the pair to a second receiver of the pair; and generating an image based on the calculated earth's response.

### TECHNICAL FIELD

Embodiments of the subject matter disclosed herein generally relate to methods and systems for seismic data acquisition and, more particularly, to mechanisms and techniques for using interferometry-based sources to optimize seismic data acquisition.

### BACKGROUND

Seismic data acquisition and processing techniques are used to generate a profile (image) of a geophysical structure (subsurface) of the strata underlying the land surface or seafloor. Among other things, seismic data acquisition involves the generation of seismic waves (e.g., acoustic waves) and the collection of reflected/refracted versions of those seismic waves to generate the image. This image does not necessarily provide an accurate location for underground deposits, but it may suggest, to those trained in the field, the presence or absence of the deposits. Thus, providing a more accurate image of the subsurface is an ongoing process in the field of seismic surveying.

The generation of seismic waves is achieved by using controlled sources. For example, for land acquisition, a seismic source, which is called a vibrator, is deployed on a truck and moved from point to point for generating the seismic waves. For marine acquisition, a vessel tows a plurality of air guns, which are discharged at given times to generate the seismic waves. Ambient noise sources (i.e., uncontrolled sources, e.g., noise from a factory, a passing train, etc.) may also be used for generating seismic waves.

The typical seismic data acquisition system 100, as illustrated in FIG. 1, includes a controlled source 102 and one or more receivers 104 located on the surface 112. Source 102 sends seismic waves 108 into the earth, which is represented by plural layers separated by respective interfaces 106. Incoming waves 108 are reflected at these interfaces (for simplicity, FIG. 1 shows a single reflection at interface 106) and these reflected waves 110 are then recorded by receivers 104.

There are situations when such seismic survey is performed over an area that has regions inaccessible to the source (remember that a land source is carried by a truck and a marine source is towed by a vessel and the source and its carrier are large objects). FIG. 2 illustrates such a situation in which source 102 is supposed to move to various positions 102's to shoot over an area 214. However, obstacle 216 (e.g., a hill, a mountain or a dwelling for a land survey or an oil rig for a marine survey) prevents the source from firing at desired position 102″.

There are situations where very low frequencies (below 5 Hz or below 2 Hz) are difficult to generate using controlled sources like vibrators or airguns while ambient noise generated by industrial equipment or motors emit signals at these frequencies.

Seismic interferometry is a technique that promises to extract seismic information from recordings at two or more receivers as the seismic waves have been fired by virtual sources located at positions where a physical source cannot be placed. In this regard, in the past ten years, many authors proposed to benefit from ambient noise sources and/or non-controlled sources to implement seismic interferometry in seismology (see e.g., Paul et al. 2005, “Empirical synthesis of time-asymmetrical Green functions from the correlation of coda waves,” Journal of Geophysical Research, 110, doi:10.1039/2004JB003521) or in the seismic exploration context (see e.g., Draganov, D., Campman, X., Thorbecke, J., Verdel A. Wapenaar K., 2009, “Reflection images from ambient seismic noise,” Geophysics, 74, 5).

However, this technique requires that the virtual source distribution is isotropic around the receivers or it covers a large area surrounding the receivers. In addition, the traditional interferometric technique is computationally intensive, which is undesired when performing a seismic survey.

Thus, there is a need to provide systems and methods that avoid the afore-described problems and drawbacks associated with seismic interferometry as part of an overall seismic data processing scheme.

### SUMMARY

Methods and systems for seismic interferometry acquisition are described herein.

According to an embodiment, there is a method for improving or generating an image of a surveyed subsurface based on seismic interferometry. The method includes actuating interferometry-based sources over an area to be surveyed to generate seismic waves; recording seismic signals due to the interferometry-based sources, with seismic receivers; selecting traces corresponding to a pair of seismic receivers and an interferometry-based source such that ray paths between the interferometry-based source and the pair of seismic receivers contribute to a Green's function between the two receivers of the pair; cross-correlating the traces for calculating an earth's response associated with a ray propagating from a first seismic receiver of the pair to a second receiver of the pair; and generating an image based on the calculated earth's response.

According to another embodiment, there is a computing device for improving an image of a surveyed subsurface based on seismic interferometry. The computing device includes an interface for receiving seismic signals recorded by seismic receivers and generated with interferometry-based sources and a processor connected to the interface. The processor is configured to select traces corresponding to a pair of seismic receivers and an interferometry-based source such that ray paths between the interferometry-based source and the pair of seismic receivers contribute to a Green's function between the two receivers of the pair; cross-correlate the traces for calculating an earth's response associated with a ray propagating from a first seismic receiver of the pair to a second receiver of the pair; and generate an image based on the calculated earth's response.

According to still another embodiment, there is a method for recording time-lapse information about a subsurface of a surveyed area. The method includes actuating interferometry-based sources over the surveyed area to generate seismic waves; recording seismic signals due to the interferometry-based sources, with seismic receivers; selecting traces corresponding to a pair of seismic receivers and an interferometry-based source such that ray paths between the interferometry-based source and the pair of seismic receivers contribute to a Green's function between the two receivers of the pair; cross-correlating the traces for calculating an earth's response associated with a ray propagating from a first seismic receiver of the pair to a second receiver of the pair; generating an image based on the calculated earth's response; and repeating the above steps later in time, using the seismic receivers which were permanently installed in the surveyed area or left in the surveyed area from a previous survey or redeployed at the same locations in the surveyed area, and located interferometry-based sources at the same surveyed positions as for the previous survey.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates a source and a seismic receiver located over a multi-layer model for an underground formation and the ray propagation from the source to the receiver;

FIG. 2 illustrates plural shot points desired for a seismic survey;

FIGS. 3A-3D illustrate the principles of seismic interferometry;

FIG. 4 illustrates various paths followed by rays recorded by a pair of seismic receivers;

FIGS. 5A and 5B illustrates the result of cross-correlating the traces corresponding to the various paths;

FIG. 6 illustrates a trace selection process;

FIG. 7 illustrates how to illuminate underground zones when a real source cannot be placed to directly illuminate those zones;

FIG. 8A illustrates a Fresnel zone for a point source;

FIG. 8B illustrates plural sources placed in a Fresnel zone corresponding to a pair of seismic receivers;

FIG. 9 illustrates plural interferometry-based sources placed along with traditional sources over an area to be surveyed;

FIG. 10 is a flowchart illustrating a method for processing seismic data according to an embodiment; and

FIG. 11 illustrates a computing device that implements one or more processes discussed herein.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. Some of the following embodiments are discussed, for simplicity, with regard to land seismic data acquisition. However, the embodiments to be discussed next are not limited to this type of data, but they may be extended to other type of data, for example, ocean bottom seismic data acquisition or permanent buried seismic acquisition.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

Prior to discussing the novelties discovered by the present inventors with regard to the seismic interferometry technique, some basic interferometry concepts are discussed next. Some of these concepts are reproduced herein from Wapenaar et al., 2010, “Tutorial on seismic interferometry: Part 1—Basic principles and applications,” Geophysics, 75(5).

Seismic interferometry refers to the idea of generating new seismic responses of virtual sources. Note that the term “virtual source” refers to the concept of obtaining real seismic data from actual recordings of seismic receivers that originate from actual seismic sources, but, by applying various mathematical processing to the actual recorded seismic data, as discussed next, the seismic data appears to originate from locations at which there are no actual sources present. In this way, these new locations act as the locations of the virtual sources.

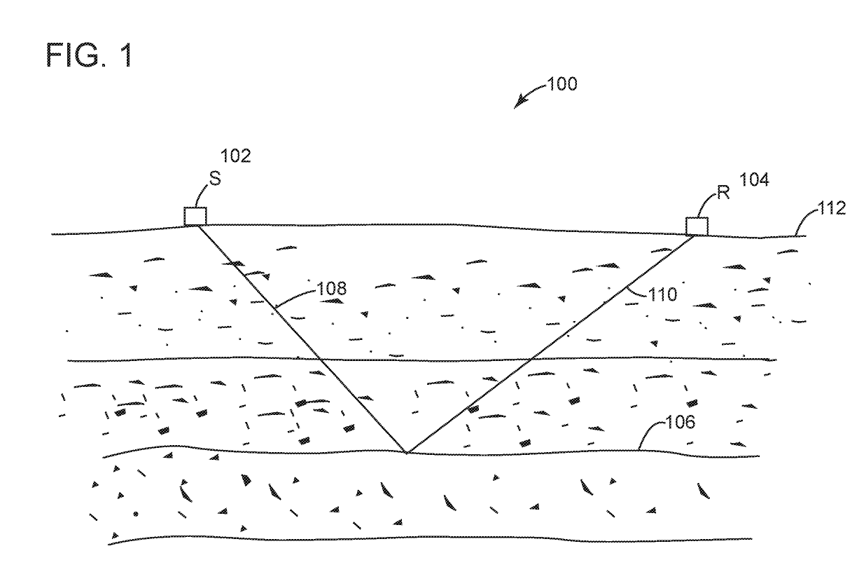

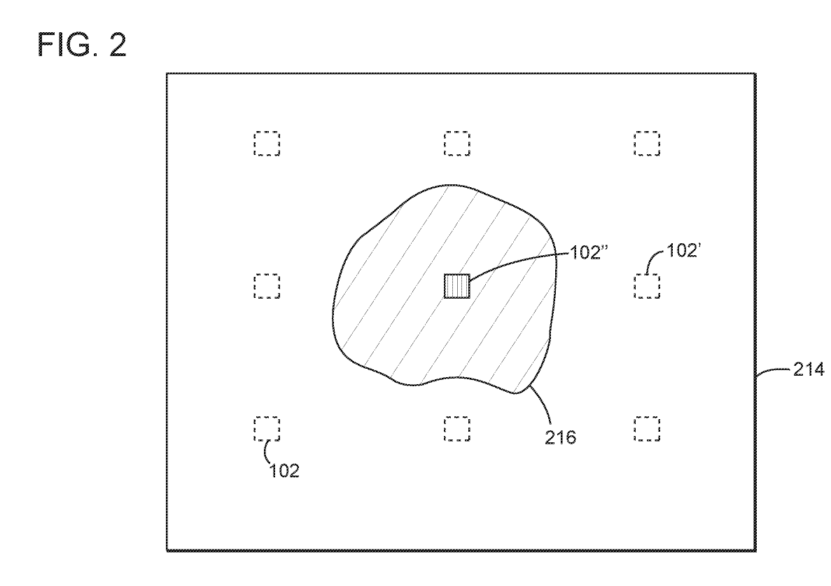

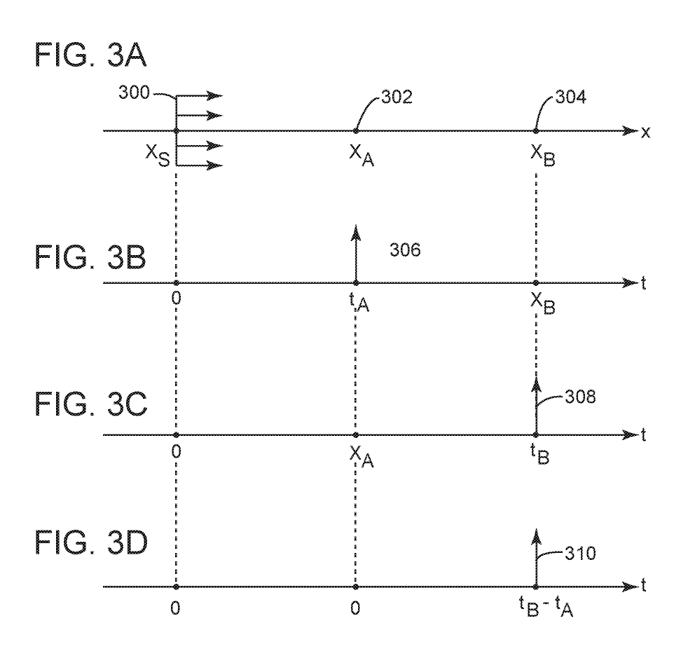

Some basic concepts of seismic interferometry are now discussed with regard to FIGS. 3A-D (corresponding to FIGS. 1a-d in Wapenaar et al.). FIG. 3A shows a plane wave 300 that is radiated by an impulsive unit source at x=x_{S} and t=0. Wave 300 propagates in the rightward direction along the x-axis. Two receivers 302 and 304 are located along the x-axis at positions x_{A} and x_{B}. FIG. 3B shows the response 306 observed by the first receiver 302 at location x_{A}. When including all the travel-paths from a source emitting at position A toward a receiver recording at position B, this response is known in the literature as G(x_{A},x_{S},t), where G stands for the Green's function, the first argument of the Green's function is the receiver coordinates, the second argument is the source coordinates, and the third argument denotes time t or angular frequency. In the example of FIG. 3B, the Green's function consists of an impulse at t_{A}=(x_{A}−x_{S})/c, where c is the speed of the wave in the medium (assumed constant for clarity and simplicity; however, if the medium is complex, the speed of the wave is not constant). Thus, for this situation, the Green's function is given by G(x_{A},x_{S}, t)=δ(t−t_{A}), where δ(t) is the Dirac delta function. Similarly, the response at x_{B} is given by G(x_{B},x_{S}, t)=δ(t−t_{B}), with t_{B}=(x_{B}−x_{S})/c, as illustrated by response 310 in FIG. 3C.

Seismic interferometry involves a cross-correlation process of the two responses 306 and 308 at the two receivers 302 and 304. FIG. 3A indicates that the ray-paths associated with G(x_{A},x_{S},t) and G(x_{B},x_{S},t) have the path from x_{S} to x_{A} in common. Thus, the travel-time along this common path cancels in the crosscorrelation process, leaving the travel-time along the remaining path from x_{A} to x_{B}, i.e., t_{B}−t_{A}. Therefore, the cross-correlation of responses 306 and 308 is an impulse 310 at t_{B}−t_{A}, as illustrated in FIG. 3D. This impulse can be interpreted as the response produced by a source at x_{A} (this is the virtual source because in reality, no physical source is placed at location x_{A}) observed by a receiver at x_{B}, i.e., the Green's function G(x_{B},x_{A}, t). An interesting observation regarding this fact is that the propagation velocity c and the position of the actual source x_{S} need not be known. Note that the Green's function represents all the paths from a source emitting at x_{A} and recorded by a receiver at x_{B}. Depending on the ambient noise and sources distribution, the correlations can retrieve only a subset of the Green's function paths. This may create mathematical problems, depending on the path of interest. In theory, the complete Green's function will be retrieved only with ambient noise sources distributed all around the two receivers, which is rarely the practical case.

The travel-times along the common path from x_{S} to x_{A} compensate each other, independent of the propagation velocity and the length of this path. Similarly, if the source impulse would occur at t=t_{S} instead of at t=0, the impulses observed at x_{A} and x_{B} would be shifted by the same amount of time t_{S}, which would be canceled in the cross-correlation process. Thus, the absolute time t_{S} at which the actual source emits its pulse need not be known.

The cross-correlation of the two Green's functions noted above are calculated as follows: G(x_{B},x_{A},t)=G(x_{B},x_{S},t)*G(x_{A},x_{S},−t), where the asterisk denotes the temporal convolution, and the time reversal of the second Green's function turns the convolution in the cross-correlation. The result of this equation is

$$δ ( t - ( {x}_{B} - {x}_{A} ) / c ) .$$

In other words, the cross-correlation of observations at two receivers 302 and 304 gives a response at one of those receivers x_{B} as if there were a source at the other receiver x_{A}. Note that the source signature is not necessarily an impulse. An impulse has been considered herein for simplicity.

This information can be used, in the case of direct-wave interferometry (i.e., a wave that propagates directly from the source to the receiver without being reflected by an interface of the earth) for two receivers with a noise field from an unknown source in a medium with unknown propagation velocity, to obtain a version of the Green's function, from which the propagation velocity of the wave between the receivers can be estimated (tomographic inversion).

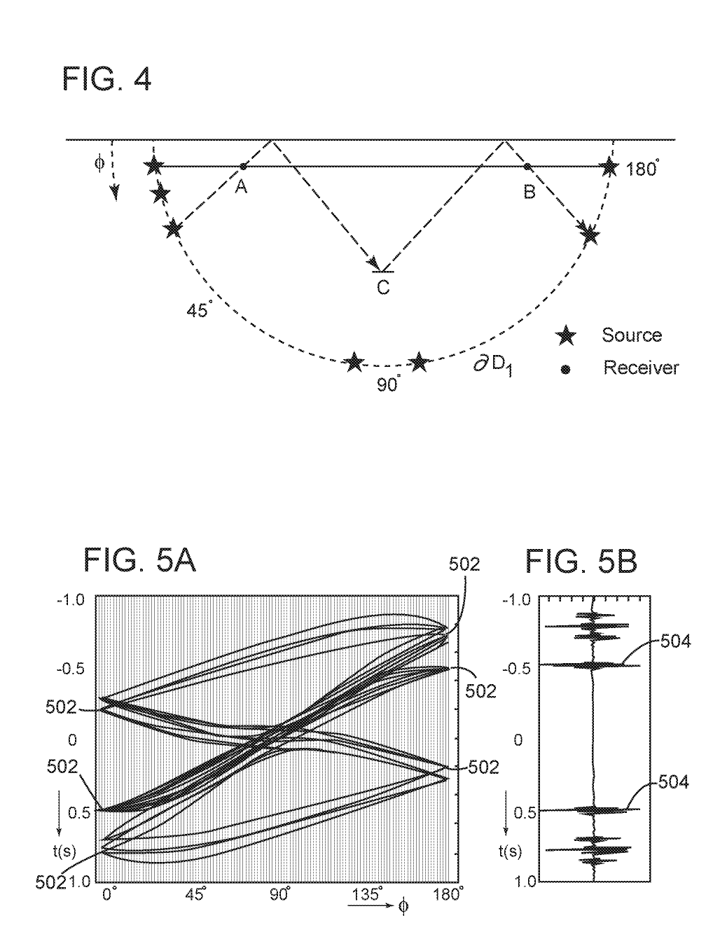

However, the seismic interferometry assumes that the ambient noise sources are distributed in a favorable manner. In some cases, the hypothesis is that the ambient source noise distribution is isotropic around the two receivers or at least distributed over a large area surrounding the two receivers (see, for example, Wapenaar, K. and Fokkema, J, 2006, “Green's function representations for seismic interferometry,” Geophysics, 71(4), Wapennar and Fokkema herein). In this regard, FIG. 4 (which is a modification of FIG. 4 of Wapenaar and Fokkema) shows receivers A and B and a single wave diffractor C (underground). The summation of the cross-correlation of the Green's functions is carried along all the sources distributed along surface ∂D₁. The contributions to the summation come from the indicated stationary points between angle φ=0° and φ=45°.

For this example, the contributions of all sources in the correlation (see FIG. 5A) are summed so that the non-relevant contributions cancel each other and only the relevant signal emerges from the correlations. The result of such summation is illustrated in FIG. 5B (which corresponds to FIG. 5b of Wapenaar and Fokkema). This result shows that the main contributions to the cross-correlation come from Fresnel zones around the stationary points 502.

FIG. 5B shows that the biggest wavelet 504 arrives around time 0.5 s, which comes from the sum of traces arriving around 0° in FIG. 5A. Other signals from traces after 10° cancel each other so that this wavelet is reconstructed only at the time of propagation of a wave emitted by a source at point A travelling directly to point B, as illustrated in FIG. 4. Another path ACB is represented for an angle around 20°. With a regular source distribution as in FIG. 4, it can be observed that angles corresponding to a true arrival time in the Green's function also correspond to an apex on FIG. 5A. Once again, for other angles, the succession of peaks observed in FIG. 5A cancels each other, resulting in a null signal on the summation displayed in FIG. 5B. Note that for sake of clarity, not all the paths are represented on FIG. 4. However, in case of complete source coverage on surface ∂D₁ in FIG. 4, all the paths travelling between receiver A position and receiver B position—i.e., the complete Green's function—will be recovered using the cross-correlations. This type of configuration is very advantageous as the full Green's function between A and B can be recovered.

According to an embodiment, the general case where the source distribution on surface ∂D₁ is sparse is considered. In this case, the destructive summation observed in FIG. 5B for sources that bring signals with inappropriate arrival times does not occur. Instead, after cross-correlation, each source provides an isolated peak signal that, generally, has nothing to do with the Green's function.

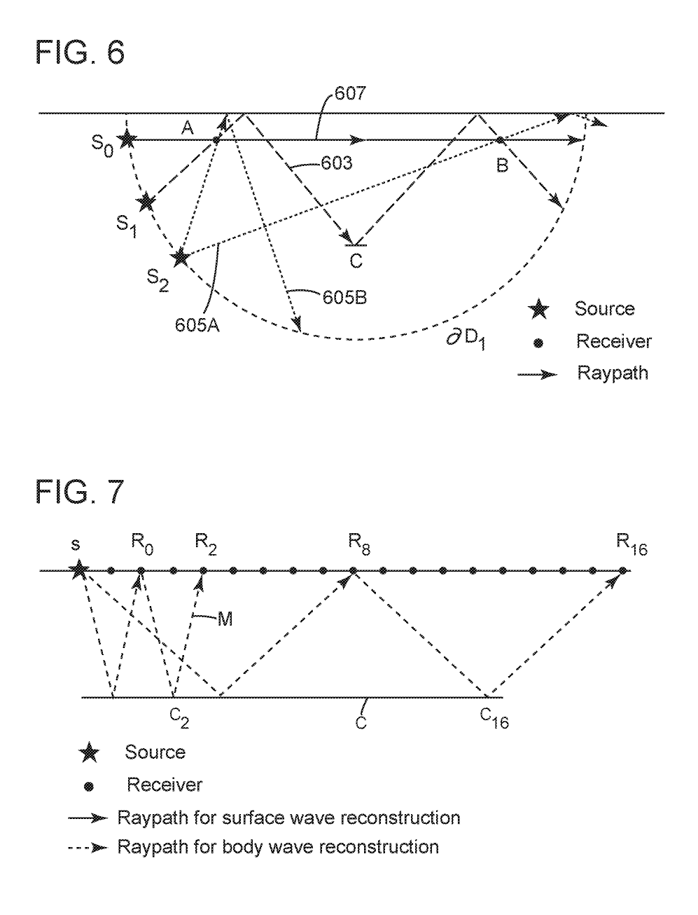

For example, for the configuration shown in FIG. 6, it is desired to reconstruct the Green's function only for the direct path AB. In this case, both sources S₁ and S₂ (see paths 603, 605A and 605B) in the figure do not contribute to this reconstruction while source S₀ (see path 607) does. This means that by correlating the signal coming from source S₀ and recorded at receiver A and the signal coming from source S₀ and recorded at receiver B, it is possible to get the earth's response for the direct path between A and B.

However, the two signals coming from S₁ and S₂ need to be removed because they provide spurious signals with regard to the direct ray path between A and B. By “spurious signal” or “spurious peak” it is understood a peak not positioned around the apex 502 in FIG. 5A and not cancelled through a summation. If it is desired to reconstruct the wave 603 reflected in C, then only the two traces including signals from S₁ and S₀ are kept and their cross-correlation provides the earth response for ray path ACB.

The signals from S₂ are not used in this case as it appears that there is no ray path coming from S₂ and travelling through A and B positions. This means that signals coming from S₂ can be considered as spurious signals and, for the case of source spatial sparsity (i.e., no uniform distribution of the sources as required in Wapenaar and Fokkema or other papers in literature), they will likely not be removed by a destructive summation.

This means that if the positions of the receivers and the sources are known, the sources having a large chance to cause spurious signal can be selected and removed from the cross-correlation calculation for sparse spatial source distribution. A process of trace selection will enhance Green's functions reconstruction and reduce computation power needs. This is possible if the source signals can be separated or if the sources emit one after the other.

Based on the above observations, according to an embodiment, a sparse spatial source distribution of interferometry-dedicated sources Sₖ is placed over an area to be seismically surveyed, in an effort to enhance the Earth's response between desired locations. If a set of N receivers Rⱼ is considered and a set of M interferometry-dedicated sources Sₖ, and their positions are known, for each pair of recorded traces (Sₖ, Rᵢ) and (Sₖ, Rⱼ), with i and j belonging to the set [1 . . . N], only those traces are considered, for the cross-correlation process of obtaining the Green's function in the seismic interferometry, that have ray paths coming from Sₖ to Rᵢ and then Rⱼ (or from Sₖ to Rⱼ and then Rᵢ) that bring a relevant contribution to reconstruct the Green's function between Rᵢ and Rⱼ or a part of this function. This trace selection process is now illustrated in FIG. 7.

FIG. 7 shows a single source S and 16 receivers R₁ to R₁₆ placed over the earth's surface. This is an example intended to illustrate one advantage of this method and not to limit its applicability. An interface C between two underground layers reflects seismic waves generated by source S. It is observed that multiples M coming from source S can be used to recover the image of some reflection points on the C horizon. For example, by correlating the primary trace (S, R₀) with the multiple trace (S, R₂), a trace that images the point C₂ is obtained (note that a primary is a ray emitted by the source, reflected on one horizon and then recorded by a receiver R, while a multiple M is a ray emitted by the source and then reflected at least twice, on the interface(s) C and/or on the top interface, and then recorded by the receiver R). The same may be observed for other pairs of receivers, up to the point C₁₆.

This configuration in FIG. 7 shows that it is possible to cover different offsets (i.e., distances between the source and receiver). This can also be useful in the case where it is not possible to have sources located between receivers R₀ and R₁₆. In other words, as long as a seismic wave emitted by source S can follow a ray path that intersects two different receivers Rᵢ and Rⱼ, a point Cⱼ between the two receivers can be considered as being illuminated with a virtual source located in Rᵢ and recorded with a receiver located at Rⱼ. This information, which is obtained from the cross-correlation of all the paths between the two receivers Rᵢ and Rⱼ replaces the real situation of placing an actual source at location Rᵢ, which many times is not possible.

To achieve these results, FIG. 7 appears to suggest that the receivers have to be positioned exactly along a ray path that travels from an actual source S towards the two receivers Rᵢ and Rⱼ. In practical terms, this constraint can be relaxed since waves do not propagate as rays, as now discussed. For each pair of receivers, it is necessary to take into account the corresponding Fresnel zone (see e.g., Wapenaar et al.).

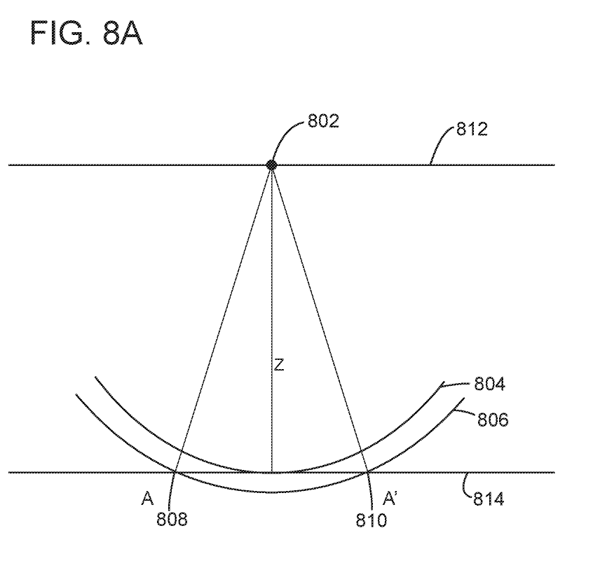

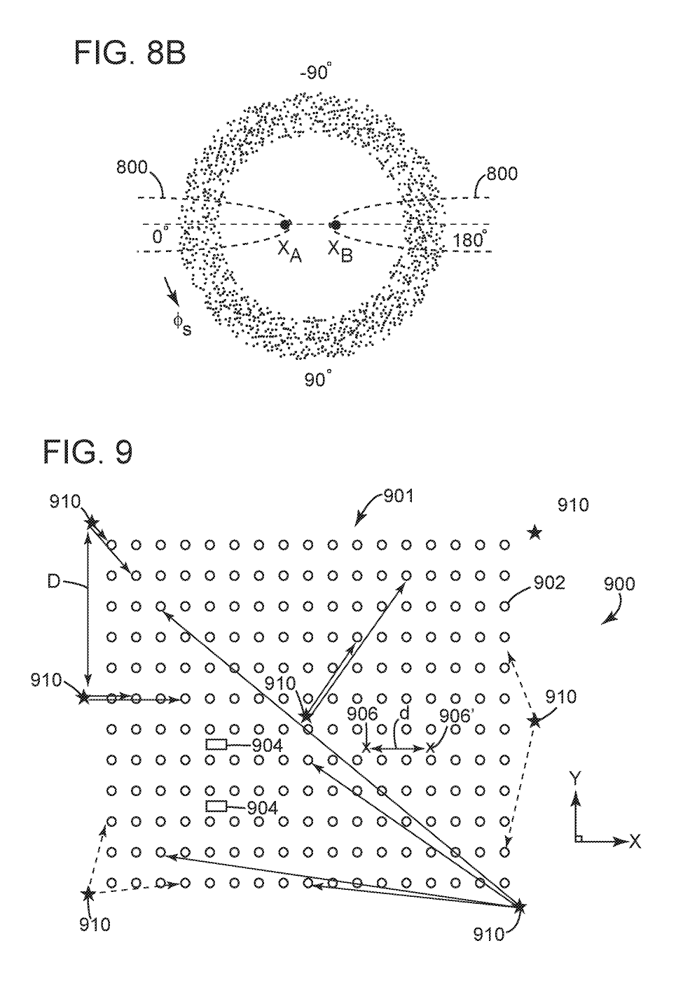

The Fresnel zone corresponds to a zone in which a source gives constructive contribution for the earth's response reconstruction between the two receivers. In other words, as illustrated in FIG. 8A, a “Fresnel zone” is the area on a reflector (where the reflector may be defined as a velocity contrast in the subsurface that causes seismic energy to be reflected) contained substantially within one quarter wavelength of an illuminating wave. More specifically, looking to FIG. 8A, a Fresnel zone is defined by locations 808 and 810 where a second wave-front 806 intersects reflector 814. Wave-front 806 is obtained by considering a source 802 at or near the surface 812 emitting a wave that propagates toward the reflector. A first wave-front 804 reaches (i.e., the reflector is tangent to the first wave-front) the reflector 814 and the second wave-front 806 propagates one fourth of the wavelength of the wave from the first wave-front 804. Thus, based on this definition of the Fresnel zone, the reflected signal is a result of the property of the reflector within the Fresnel zone bounded at reflector locations “A” 808 and “A” 810. It should be noted that a reflection thought of as coming back to the surface from a point is actually being reflected from an area having the dimension of the Fresnel zone. This is equivalent to saying that rays generated by a distribution of seismic sources can be recorded by a single receiver as long as the sources are located within a Fresnel zone.

For the receiver configuration illustrated in FIG. 7, the Fresnel zone is illustrated in FIG. 9 and it corresponds to the dotted areas 800. In this case, all the sources present within the Fresnel zone 800 provide relevant contributions to reconstruct the direct paths earth's response between the two receivers positioned at locations X_{A} and X_{B}. This means that a perfect alignment of the source with the two receivers along a common plane is not necessary. The source should only be located in a Fresnel zone corresponding to the two receivers. This observation relaxes the isotropy condition of the actual seismic sources noted in Wapenaar et al. Note that FIG. 8B, which corresponds to FIG. 6a of Wapenaar et al. indicates that the sources are distributed uniformly around the two receivers, i.e., the case of isotropic illumination.

For the case of sparse sources distribution, as illustrated in FIG. 7, only few—sometime only one—source(s) need to be in the Fresnel zone. Thus, the Green's function reconstruction for this setup can suffer from some imperfections comparative to the theoretical assumptions noted in Wapenaar et al. Nevertheless, if a sufficient number of traces are collected, useful results are achieved. An example in this regard is now discussed with regard to FIG. 9.

FIG. 9 shows a land seismic survey 900 that includes plural seismic receivers 902 (illustrated in this example as distributed over a regular grid, i.e., parallel lines to the X axis intersected by parallel lines to the Y axis). The plural seismic receivers are known in the art as the seismic spread 901. A distance between two adjacent seismic sensors in FIG. 9 is about 25 m. FIG. 9 also shows seismic sources (e.g., vibrators) 904 that move from location to location (shot point) for generating seismic waves. A typical distance “d” between two adjacent shot points 906 and 906′ along a given direction (e.g., axis X) for such a controlled source 904 is smaller than 100 m.

FIG. 9 further shows, in addition to the traditional controlled sources 904, a number of interferometry-based sources 910 that are added for the purpose of creating virtual sources as discussed above, i.e., creating favorable conditions for seismic interferometry processing. In other words, by having only the traditional sources 904, seismic interferometry processing may not be performed as the seismic interferometry processing involves cross-correlation of traces recorded at two receivers under the conditions discussed above.

The interferometry-based sources 910 are different from the traditional sources 904, in the sense that while a traditional source 904 (e.g., vibrator for land or air gun for marine) is controlled by the operator of the survey to shot at given shot points with a controlled signal, the interferometry-dedicated sources are not controlled when to shot. However, the positions of the interferometry-based sources are controlled based on the configuration of the seismic receivers. In this regard, FIG. 9 shows seven interferometry-dedicated sources 910, four located at the corners of the seismic spread 901, two on opposite sides of the spread, and one in a central position of the spread.

Note that a distance “D” between adjacent interferometry-based sources 910 may be in the order of hundreds to thousands of meters. In one application, the distance D is at least one order of magnitude larger than distance d. In still another application, the number of interferometry-based sources per square kilometer is less than 10. One skilled in the art would know that the number of shot points, for the traditional sources, per square kilometer is in the order of tenths for explosive sources, hundreds if not thousands for vibrators or airgun sources while the number of shot points, for the interferometry-based sources, is less than ten.

An interferometry-based source may be the motor of a traditional source, the motor of a support vehicle, or any machine that produces a noise-like sound and which position can be controlled as illustrated in FIG. 9. In this regard, a train passing by the seismic survey or a passing tractor-trailer or an earthquake are not considered as being an interferometry-based source as their positions cannot be controlled by the operator of the seismic survey. However, a truck or a car or a bulldozer on site, at a controlled position, is considered to be an interferometry-based source. Such sources may have the advantage of emitting ambient noise with low frequency content (below 3 Hz or below 2 Hz) that will enrich the final image when using correlations. In one embodiment, a position of the interferometry-based source has to be controlled by the seismic survey's operator for generating traces that meaningfully contribute to the cross-correlation operation of the seismic interferometry process. In other words, in one application, the survey's operator needs to control the interference-based source to locate it in the Fresnel zone corresponding to the selected pair of receivers.

Although the number of interferometry-based sources is small, the cross-correlation operation can provide a quite large number of traces with varying offset and/or incidence angle as illustrated in FIG. 9. In this regard, note that each pair of solid lines in FIG. 9, leaving an interferometry-based source 910, indicates a relevant pair of traces while a pair of dashed lines leaving an interferometry-based source 910 indicates an irrelevant pair of traces. Further note that by placing interferometry-based sources at opposite sides of the spread allow for opposite azimuthal illumination. Additionally, the configuration shown in FIG. 9 can be repeated over a larger area.

The configuration illustrated in FIG. 9 may be varied as would be understood by one skilled in the art. For example, it is possible that positions of the sources and receivers are pre-computed according to any relevant information to optimize the cross-correlation efficiency. In one application, it is possible that each interferometry-based source is emitting one after the other. In still another application, two or more interferometry-based sources are emitting at the same time.

In one application, all the relevant cross-correlations are computed after selection of the sources present in one or more Fresnel zones associated with the selected pair of receivers. In another application, the interferometry-based source selection is achieved using a method less precise than the Fresnel zone computation. This selection could use the azimuth difference between the two source-receivers pair involved in the cross-correlation. In still another application, no interferometry-based source selection is performed. In one application, the interferometry-based sources are randomly distributed over the seismic spread.

In another application, two or more interferometry-based sources emit at the same time. The acquired data can then be processed with no source separation algorithm or with a source separation algorithm (like filtering, deblending, etc.). If all interferometry-based sources are emitting at the same time, only the knowledge of the beginning and the end emission times are necessary to avoid correlating unknown signals. For this case, the time precision can be very low. For example, for 10 minutes record length, a time error of 1, 5 or 10 seconds is acceptable.

In case that the interferometry-based sources emit according to a specific time schedule, the emission time of the sources are to be known to properly achieve a source separation in the time domain. Once again, the precision of the beginning and the end of the emission time need only a coarse precision. This is due to the fact that the cross-correlation operation also performs redatuming. The only precision requirement is that of the synchronization of a pair of seismic receivers to be cross-correlated, which is ensured by any state-of-the-art recording system.

In one application, the interferometry-based source signal is designed to fit any specific frequency content. For example, in one embodiment the interferometry-based sources can emit either conventional signals (like a frequency sweep or specific wavelets) or unconventional signals (like pseudo-random noise, discontinuous spectrum, etc.).

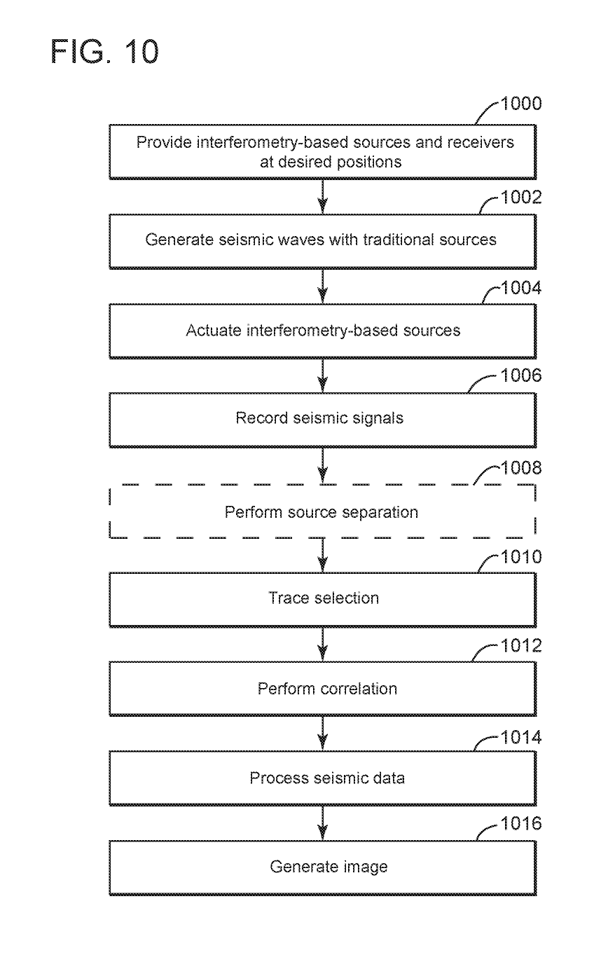

A method for performing a seismic survey using traditional seismic sources and interferometry-based sources is now discussed with regard to FIG. 10. In step 1000, the interferometry-based sources 910 and the seismic receivers 902 are placed into positions above the area to be surveyed. Both the interferometry-based sources and the receivers are placed at desired positions, i.e., their positions are controlled. Note that the surveyed area may be on land or underwater.

In step 1002, traditional seismic sources 904 (e.g., vibrators, air guns, explosives, etc.) are driven from shot point to shot point and actuated for generating seismic waves into the earth. However, in a pure interferometry schematic configuration, the traditional seismic sources are not shot. In step 1004, the interferometry-based sources are activated (either continuously or intermittently). The traditional seismic sources and the interferometry-based sources may be activated at the same time, i.e., simultaneously, or in a sequence. For example, if the interferometry-based source is an engine, it can run continuously during a given time period while the traditional seismic sources may be fired during the same given time period. In one application, the interferometry-based sources are fired during the given time period and the traditional seismic sources may be fired during a different time period. In one application, the interferometry-based sources are run a shorter time than the traditional seismic sources (e.g., the interferometry-based sources are run for a couple of hours while the traditional seismic sources are run for days). In one application, it is possible that the engine of the traditional seismic source is the interferometry-based source.

In step 1006, seismic data is recorded with the plural seismic receivers 902. The seismic data will include signals corresponding to both the traditional sources (if these sources are shot) and the interferometry-based sources. Note that the interferometry-based source may emit lower frequencies than the traditional seismic bandwidth, for example in the 0-2 or 0-3 Hz range. Such a low frequency range is hardly emitted by today traditional seismic sources. Thus, by generating such low frequency seismic waves, a better image of the surveyed subsurface may be achieved. Optionally, a source separation algorithm may be applied in step 1008 to the recorded seismic data, for separating the recorded signals if the traditional sources have been fired simultaneously.

In step 1010, a trace selection process is applied. The trace selection process, as discussed above, selects those traces that are associated with a pair of receivers and one interferometry-based source located in a Fresnel zone corresponding to the pair of receivers (see FIGS. 8B and 9). In one embodiment, the selection of based on a common azimuth of the interferometry-based source and the pair of receivers. In still another embodiment, the selection is made such that ray paths between the interferometry-based source and the pair of seismic receivers contribute to the Green's function between the two receivers of the pair. Note that the selected traces are relevant for body waves retrieval. The body waves retrieval is achieved in step 1012 by cross-correlating the selected traces for the pair of receivers. This process can be repeated for any number of pairs of receivers and associated interferometry-based source located in the corresponding Fresnel zone. This means that in this step, not all the traces recorded in step 1006 are used for calculating the cross-correlations. The seismic interferometry process discussed herein advantageously enhances the near-surface imaging after migration as disclosed, for example, in de Cacqueray et al., 2016, “Use of Ambient Noise to Enhance Low Frequencies Seismic Migration Images,” 78th EAGE Conference and Exhibition, Vienna. Alternatively or in addition, this method is advantageous for any scenario in which the interferometry-based source distribution has to be sparse. The term “sparse” is defined for this application to be one or less interferometry-based source per square kilometre.

With the results from the correlation step 1012, further data processing is performed in step 1014. This step may include pre-processing methods, e.g., demultiple, signature deconvolution, trace summing, vibroseis correlation, resampling, etc. This step may also include a main processing phase, e.g., deconvolution, amplitude analysis, statics determination, common middle point gathering, velocity analysis, normal move-out correction, muting, trace equalization, stacking, noise rejection, amplitude equalization, etc. Final or post-processing may be applied and they may include migration, wavelet processing, inversion, etc. In step 1016, an image of the surveyed data is generated based on the seismic data processed in step 1014. In one application, the above steps may be repeated later in time, using the seismic receivers, which were permanently installed in the surveyed area or left in the surveyed area from a previous survey or redeployed at the same locations in the surveyed area, and interferometry-based sources located at the same surveyed positions as for the previous survey.

The above discussed method may be applied to interferometry-based source: installed and used at a given source position (e.g., during a 3D exploration survey), or installed and used at a given source position and then moved to another position to increase the subsurface illumination (e.g., 3D exploration), or installed at a given source position and then removed and re-installed at the same source position at different points in time to record time lapse information (e.g., 4D exploration), or installed at a given source position for a given time span and then used at different points in time to record time lapse information (e.g., 4D exploration).

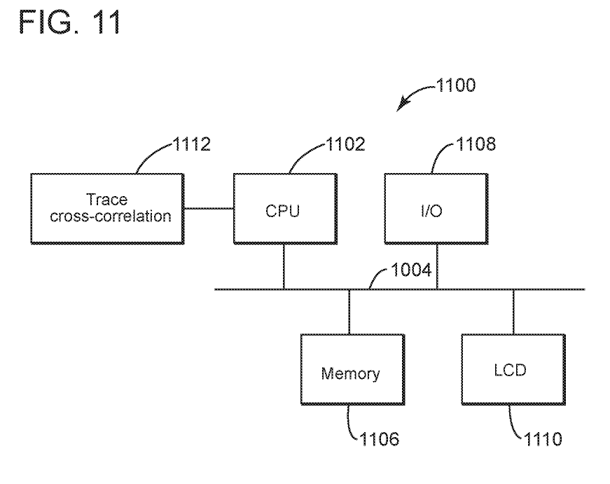

An exemplary computing device for running the methods and/or processed discussed above is illustrated in FIG. 11. The computing device 1100 includes a processor 1102 that is connected through a bus 1104 to a storage device 1106. Computing device 1100 may also include an input/output interface 1108 through which data can be exchanged with the processor and/or storage device. For example, a keyboard, mouse or other device may be connected to the input/output interface 1108 to send commands to the processor and/or to collect data stored in storage device or to provide data necessary to the processor. In one application, the processor calculates the cross-correlations of the selected traces, which may be provided through the input/output interface. Results of this or another algorithm may be visualized on a screen 1110. Although the elements of computing device 1100 appear to be routine, it is noted that due to the complexity of the seismic data and its sheer size, the computing device is usually a dedicated supercomputer. In one embodiment, the supercomputer also includes a trace cross-correlation module 1112, which provides software instructions to the processor 1102 for calculating the Green's function for pairs of receivers and associated interferometry-based sources.

Although the features and elements of the present embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a general purpose computer or a processor.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for improving or generating an image of a surveyed subsurface based on seismic interferometry, the method comprising:
actuating interferometry-based sources over an area to be surveyed to generate seismic waves;
recording seismic signals due to the interferometry-based sources, with seismic receivers;
selecting traces corresponding to a pair of seismic receivers and an interferometry-based source such that ray paths between the interferometry-based source and the pair of seismic receivers contribute to a Green's function between the two receivers of the pair;
cross-correlating the traces for calculating an earth's response associated with a ray propagating from a first seismic receiver of the pair to a second receiver of the pair; and
generating an image based on the calculated earth's response.

2. The method of claim 1, wherein the interferometry-based source is located in a Fresnel zone associated with the pair of seismic receivers.

3. The method of claim 1, further comprising:
controlling positions of the interferometry-based sources.

4. The method of claim 1, further comprising:
actuating traditional seismic sources over the area to be surveyed, wherein a number of the interferometry-based sources is smaller than a number of the traditional seismic sources.

5. The method of claim 4, wherein a number of surveyed positions of the interferometry-based sources is at least one order of magnitude smaller than a number of surveyed positions of the traditional seismic sources.

6. The method of claim 4, wherein the traditional seismic sources are vibrators or air guns and the interferometry-based sources are engines of the vibrators or a propeller related noise or a vessel motion related noise.

7. The method of claim 1, wherein the traditional seismic sources are fired simultaneously with the interferometry-based sources.

8. The method of claim 1, wherein the interferometry-based sources are sparsely distributed over the area.

9. The method of claim 1, wherein a distribution of the interferometry-based sources is not isotropically distributed around the pair of seismic receivers.

10. The method of claim 9, wherein a non-isotropic character of the source distribution is corrected by a processing sequence.

11. A computing device for improving an image of a surveyed subsurface based on seismic interferometry, the computing device comprising:
an interface for receiving seismic signals recorded by seismic receivers and generated with interferometry-based sources; and
a processor connected to the interface and configured to,
select traces corresponding to a pair of seismic receivers and an interferometry-based source such that ray paths between the interferometry-based source and the pair of seismic receivers contribute to a Green's function between the two receivers of the pair;
cross-correlate the traces for calculating an earth's response associated with a ray propagating from a first seismic receiver of the pair to a second receiver of the pair; and
generate an image based on the calculated earth's response.

12. The computing device of claim 11, wherein the interferometry-based source is located in a Fresnel zone associated with the pair of seismic receivers.

13. The computing device of claim 11, wherein the processor is further configured to:
control positions of the interferometry-based sources.

14. The computing device of claim 11, wherein the interface receives seismic data associated with firing of traditional seismic sources over the area to be surveyed,
wherein a number of the interferometry-based sources is smaller than a number of the traditional seismic sources.

15. The computing device of claim 11, wherein a number of surveyed positions of the interferometry-based sources is at least one order of magnitude smaller than a number of surveyed positions of the traditional seismic sources.

16. The computing device of claim 11, wherein the traditional seismic sources are vibrators or air-guns and the interferometry-based sources are engines of the vibrators or a propeller related noise or a vessel motion related noise.

17. The computing device of claim 11, wherein the traditional seismic sources are fired simultaneously with the interferometry-based sources.

18. The computing device of claim 11, wherein the interferometry-based sources are sparsely distributed over a given area.

19. The computing device of claim 11, wherein a distribution of the interferometry-based sources is not isotropically distributed around the pair of seismic receivers.

20. A method for recording time-lapse information about a subsurface of a surveyed area, the method comprising:
actuating interferometry-based sources over the surveyed area to generate seismic waves;
recording seismic signals due to the interferometry-based sources, with seismic receivers;
selecting traces corresponding to a pair of seismic receivers and an interferometry-based source such that ray paths between the interferometry-based source and the pair of seismic receivers contribute to a Green's function between the two receivers of the pair;
cross-correlating the traces for calculating an earth's response associated with a ray propagating from a first seismic receiver of the pair to a second receiver of the pair;
generating an image based on the calculated earth's response; and
repeating the above steps later in time, using the seismic receivers, which were permanently installed in the surveyed area or left in the surveyed area from a previous survey or redeployed at the same locations in the surveyed area, and interferometry-based sources located at the same surveyed positions as for the previous survey.
